(19) United States
(12) Patent Application Publication
(10) Pub. No.: US 2001/0040346 A1
(43) Pub. Date: Nov. 15, 2001

(54) PISTON RING ASSEMBLY

(76) Inventor: KAZUTOSHI TAKASHIMA, HAMAMATSU-SHI (JP)

Correspondence Address: KNOBBE MARTENS OLSON & BEAR LLP, 620 NEWPORT CENTER DRIVE, SIXTEENTH FLOOR, NEWPORT BEACH, CA, 92660, US

(21) Appl. No.: 09/220,517

(22) Filed: Dec. 24, 1998

(30) Foreign Application Priority Data
Dec. 24, 1997 (JP) 9-354523

(51) Int. Cl. F16J 9/00

(52) U.S. Cl. 277/434

(57) ABSTRACT

A piston and piston ring assembly has a compression ring and a lubrication control ring. The compression ring substantially seals a combustion chamber from a crankcase chamber. The lubrication control ring is configured with a reverse-taper end surface and a wiping edge. The reverse-taper end surface allows the lubrication control ring to leave a thin lubricant coat on a cylinder wall during a piston downstroke. The wiping edge pulls lubricant upward toward the compression ring during a piston upstroke. The combination of the elements and the elements on their own result in enhanced lubrication of the compression ring and thereby increase the life of the piston ring and reduce the wear on the ring and the cylinder bore.

### BACKGROUND OF THE INVENTION

1. Field of the Invention

The present invention generally relates to piston rings for internal combustion engines. In particular, the present invention relates to a lubricant control ring for twostroke engines.

2. Description of Related Art

Internal combustion engines operate on alternating compression and expansion cycles, which cycles reflect a state of operation within a combustion chamber. During the compression cycle, the compression of an air and fuel mixture typically precedes an ignition of the air and fuel mixture. The ignition of the air and fuel mixture results in combustion of the air and fuel mixture and an accompanying expansion within the combustion chamber. The expansion is followed, or accompanied, by an exhaust cycle.

The compression and expansion is generally enabled by a piston which reciprocates within a cylinder bore. Because the diameters of the piston and the receiving cylinder bore differ, a sealing arrangement is necessitated. Accordingly, one or more circumferential grooves are provided within an upper end of the piston. To provide a seal, resilient rings are installed in these grooves, which rings have a slightly larger exterior diameter than the piston. The rings generally bear directly against the cylinder wall and create a seal between the sides of the piston ring groove and the cylinder wall.

Recognition of the Problem

With reference to FIG. 1, an earlier embodiment of the present invention is illustrated therein. As illustrated, a portion of a piston 20 is shown in cross-section. The piston 20 reciprocates within a cylinder bore 22 in a cylinder block 24. The diameter of the piston 20 must be less than the diameter of the cylinder bore 22 such that the piston 20 may reciprocate relatively freely therein.

To create a substantially sealed combustion chamber 26, the piston 20 has a plurality of piston rings. The uppermost piston ring is a top compression ring 28 while the second ring is a lubricant scraping ring 30. The top compression ring 28 is designed to seal against fluid migration between the combustion chamber and a crankcase (not shown) and vice versa. Conversely, the lubricant scraping ring 30 may scrape oil or other lubricant off the cylinder bore 24 during the down stroke of the piston. Each of the rings is designed to provide for a ring gap between the outermost surface of the rings and the cylinder bore 24 that is adequate to avoid interference under the most severe operation condition (i.e., the high temperature/ high load operation of the engine).

In the prior embodiment, the lubricant scraping ring 30 was shaped to ensure an acute angle of contact between a scraping edge of the piston ring 30 and the cylinder bore 24. Additionally, as illustrated in FIG. 1, the scraping edge had a substantial contact surface which was designed to slide along the cylinder bore wall. Accordingly, with continued reference to FIG. 1, the lubricant scraping ring 30 blocked a substantial portion of the oil splashed upward from the crankcase chamber side of the piston ring 30. Because the oil was blocked by the lubricant scraping ring 30, adequate oil was not supplied to the top compression ring 28. As a result, the top compression ring 28 wore quickly or the cylinder bore 22 was scored by dry running piston rings 28 within the cylinder bore 22.

### SUMMARY OF THE INVENTION

Accordingly, an improved oil control ring is desired which will encourage proper lubrication of the top compression ring under all running speeds.

One advantage of the present invention involves a second or oil control ring that has a reverse taper shape. The reverse taper shape allows oil deposited on the inner cylinder wall to be pushed up and supplied to the top ring during upward piston movement. Moreover, the reverse taper shape allows a portion of the oil deposited on the inner cylinder wall to be scraped off while preparing a portion of the oil for supply to the top compression ring during such an upward piston movement. Accordingly, the lubrication of the top compression ring is remarkably improved and the life of the piston ring may also be increased.

One feature of the present invention involves a piston and piston ring assembly for a direct injection internal combustion engine. The piston comprises a head and at least two circumferential ring grooves positioned proximate the head. A compression ring is positioned within the top ring groove and a second ring is positioned within the second ring groove. The second ring preferably has a top surface and a bottom surface wherein the top surface has a greater outside diameter than the bottom surface. A reverse-taper side surface extends between the outside edge of the top surface and the bottom surface. The upper end of the reverse-taper side surface forms a wiping edge of the second ring.

Another aspect of the present invention also relates to a piston and piston ring assembly for use within a cylinder of an internal combustion engine. The piston and piston ring assembly desirably has a piston having a piston ring groove and a head. The piston ring groove has a width at its inner diameter and a piston ring is positioned in the piston ring groove. The piston ring preferably has a top surface generally facing toward the piston head and a thickness at its innermost edge. The top surface extends outward to a wiping edge. A side face depends downward from the wiping edge and extends inward toward the piston. The piston ring thickness is preferably less than the piston ring groove width and the wiping edge is arranged to wipe a portion of a lubricant film from a cylinder wall.

### BRIEF DESCRIPTION OF THE DRAWINGS

These and other features, aspects and advantages of the present invention will now be described with reference to the drawings of a preferred embodiment that is intended to illustrate and not to limit the invention, and in which:

FIG. 1 is a depiction of a previous embodiment that led to the present invention;

FIG. 2 is a partially schematic view having three portions that are connected by a controlling ECU of an engine having piston rings arranged and configured in accordance with certain aspects of the present invention, the lower right hand portion of this view depicting a side elevational view of an outboard motor, the lower left hand side depicting a rear elevational view of the outboard motor on an enlarged scale and a partial cross-section of the engine taken through the cylinders and exhaust manifold and the upper portion depicting a top plan view of the engine and the fuel supply system with portions shown schematically and in broken line;

FIG. 3 is an enlarged and more complete view of the outboard motor as shown in the lower left hand view of FIG. 2;

FIG. 4 is an enlarged cross-sectional view taken through a single cylinder of the engine of FIG. 2 depicting a piston ring arrangement configured in accordance with certain aspects of the present invention;

FIG. 5 is a cross-sectional view taken along the line 5-5 in FIG. 4 illustrating a scavenging air flow pattern and a path of injected fuel;

FIG. 6 is an enlarged partial cross-sectional view of a portion of the piston, piston ring and cylinder contained within the circle 6 of FIG. 4; and

FIG. 7 is a graphical illustration of top piston ring wear when combined with the previous embodiment of an oil scraping piston ring versus top piston ring wear when combined with a lubricant control piston rings arranged and configured in accordance with certain aspects of the present invention.

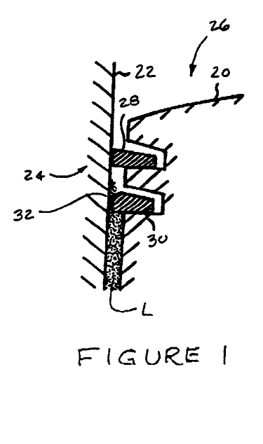

### DETAILED DESCRIPTION OF THE PREFERRED EMBODIMENTS OF THE INVENTION

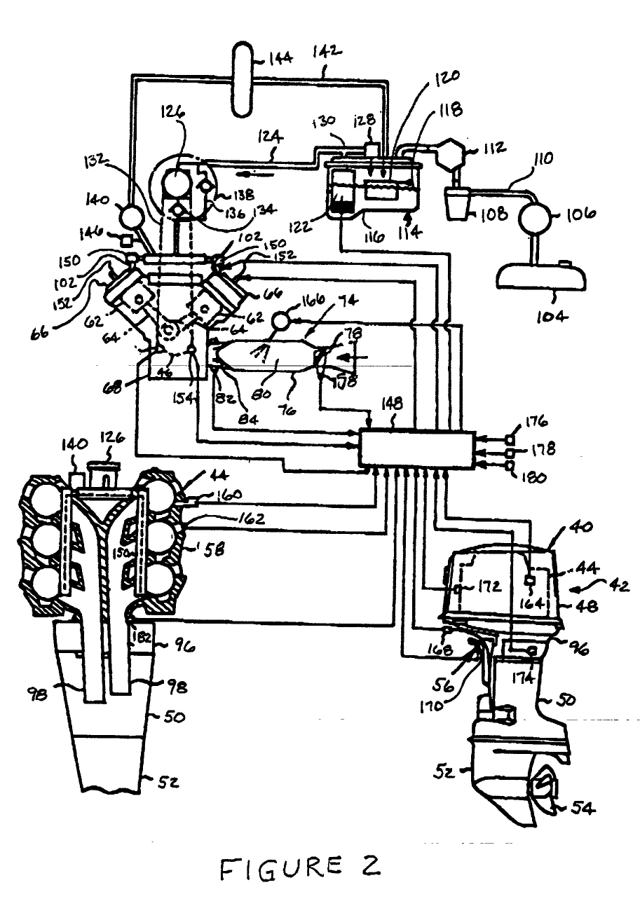

Referring initially to FIG. 2, the lower right hand portion of this view illustrates a side elevational of an outboard motor having certain features of the present invention. The outboard motor is indicated generally by the reference numeral 40 and, except as will be hereinafter noted, may be considered to be of a generally conventional construction.

The outboard motor 40 is comprised of a power head 42 that contains a powering internal combustion engine 44. As best seen in the other two portions of this figure, the engine 44 is, in this embodiment, of the V6 type and operates on a two stroke crankcase compression principal. Although the number of cylinders and cylinder orientation can be varied, the invention has particularly utility in connection with two cycle engines and particularly those having multiple cylinders, but certain aspects of the present invention may also applicable to four cycle engines.

As is typical with outboard motor practice, the engine 44 is supported in the power head 42 so that its crankshaft 46 rotates about a vertically extending axis for a reason which will be described momentarily.

The power head 42 is completed by a protective cowling 48 that surrounds and protects the engine 44. This protective cowling 48 is formed with an air inlet opening so that induction air for operation for the engine 44 can be drawn from the surrounding atmosphere.

The engine 44, and specifically its crankshaft 46, is coupled to a driveshaft (not shown) that depends into and is journaled within a driveshaft housing 50 and lower unit 52 assembly. This is the reason for the vertical orientation of the axis of rotation of the crankshaft 46. This driveshaft (not shown) depends into the lower unit 52 where it drives a propulsion device for an associated watercraft through a suitable transmission. In the illustrated embodiment, the propulsion device comprises a propeller 54 which is selectively driven in forward and reversed directions through a bevel gear reversing transmission (not shown) of the type well known in this art.

The outboard motor 20 also includes clamping and swivel brackets 56 or another arrangement for mounting it to the transom of an associated watercraft. Since these types of constructions are well known in the art, further description of them is not believed to be necessary to permit those skilled in the art to practice the invention. The mounting arrangement is such, however, that the height and trim angle of the propeller 54 may be adjusted, even during running.

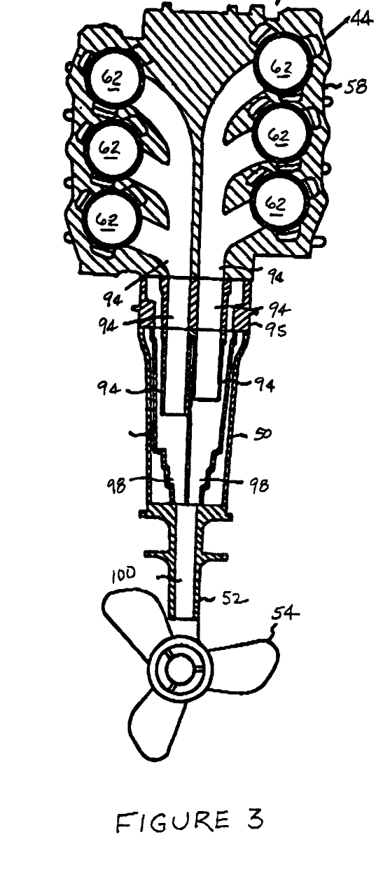

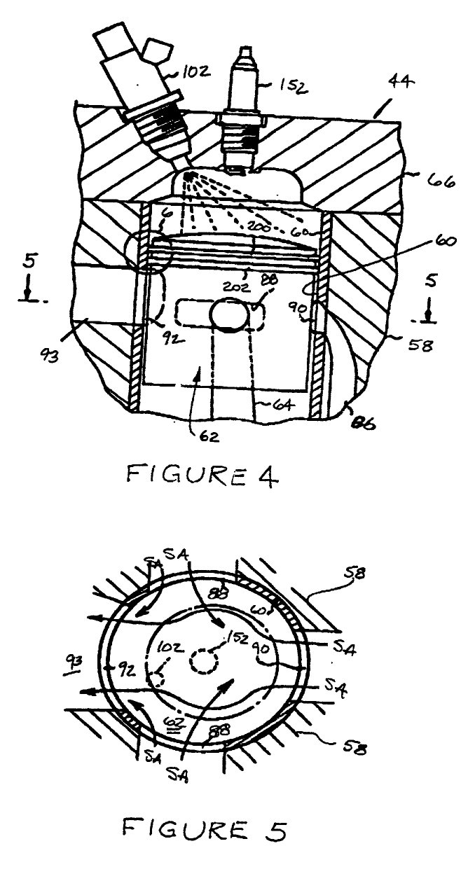

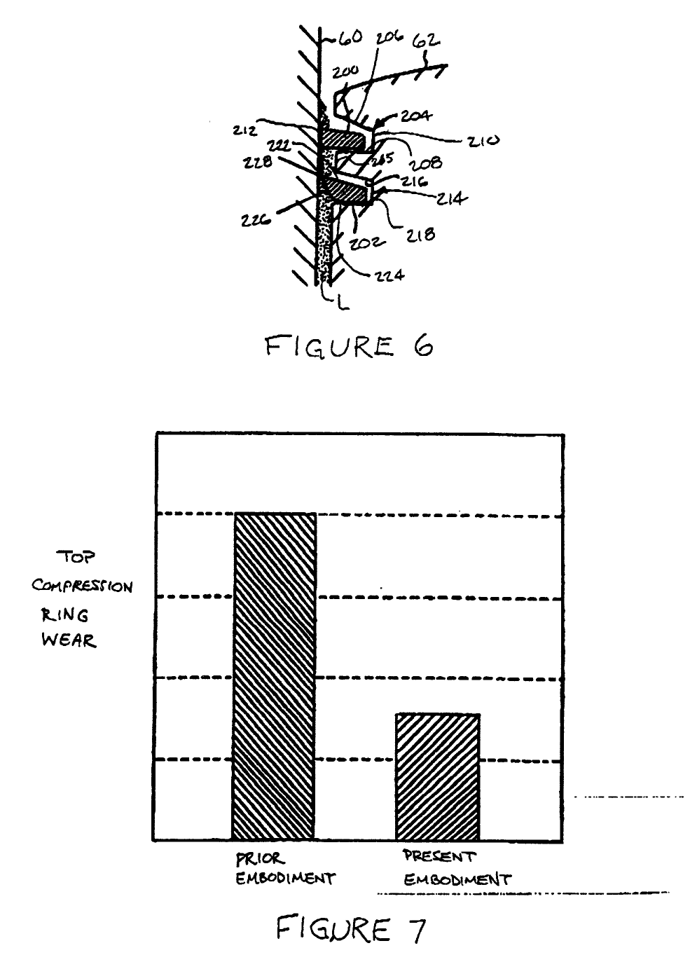

Referring now primarily to the lower left hand view and the upper view of FIG. 2 and additionally to FIG. 3, the engine 44 includes a cylinder block, indicated generally by the reference numeral 58. Because of the V-type configuration employed in this embodiment, the cylinder block 58 is formed with two cylinder banks each of which has three vertically spaced cylinder bores 60. Pistons 62 are slidably supported in the cylinder bores 60. The pistons 62 are connected by means of connecting rods 64 to the throws of the crankshaft 46 for driving it in a known manner.

Cylinder head assemblies 66, indicated generally by the reference numeral 66 are affixed to the banks of the cylinder block 58 and close the cylinder bores 60. These cylinder head assemblies 66, the cylinder bores 60 and the pistons 62 form the combustion chambers 68 of the engine 44.

The crankshaft 46 rotates in a crankcase chamber defined by the cylinder block 58 and a crankcase member 70 that is affixed thereto. As is typical with two cycle crankcase compression engines, the sections of the crankcase chamber, indicated schematically at 72, associated with each of the cylinder bores 60 are sealed from each other.

An air charge is delivered to these individual crankcase chamber sections 72 by an air induction system which appears also in the upper portion of FIG. 2 and which is indicated generally by the reference numeral 74. This induction system 74 includes an air inlet device 76 that may include a silencing arrangement and which draws air from within the protective cowling 48 that has been admitted through the aforenoted inlet opening.

A throttle valve 78 is provided in throttle bodies that communicate with the intake device 76 and deliver it to intake manifold runners 80 of an intake manifold assembly. The throttle valves 78 are controlled in any suitable manner to satisfy the operator demand. The intake manifold runners 80 communicate with intake ports 82 formed in the crankcase member 70 and each associated with a respective cylinder bore 60. Reed type check valves 84 are provided in the manifold runners 80 adjacent the intake ports 82. These reed type check valves 84 permit an air charge to be drawn into the crankcase chambers 72 when the respective pistons 62 are moving upwardly in their cylinder bores 60. As the pistons 62 move downwardly, the charge in the crankcase chambers 72 will be compressed and the respective reed type check valve 84 will close to preclude reverse flow.

Referring now additionally to FIGS. 4 and 5, it will be seen that each cylinder bore 60 is provided with a scavenging system. In the illustrated embodiment, the scavenging system is of the Schnurl type and includes a pair of side, main scavenge ports 86 and a center, auxiliary scavenge port 88. Scavenge passages 86 communicate the crankcase chambers 68 with each of the scavenge ports 88 and 90. As is well known in two cycle practice, the scavenge ports 88 and 90 are opened and closed by the reciprocation of the pistons 62 in the cylinder bores 60.

It should be noted that the main scavenge ports 88 are disposed on opposite sides of an exhaust port 92 which is diametrically opposite the auxiliary scavenge port 90. As may be best seen in the lower left hand portion of FIG. 2 and in FIG. 3, the exhaust ports 92 communicate with exhaust manifolds 94 via exhaust passages 93, both of which members 93, 94 are formed integrally within the cylinder block 58. Basically, there is an exhaust manifold 94 for each bank of cylinders.

These exhaust manifolds 94 extend through an exhaust guide 95 and terminate in exhaust pipes 96 that depend into a pair of expansion chambers 98 formed in the driveshaft housing 50 and lower unit 52. These expansion chambers 98 communicate with a suitable high-speed underwater exhaust gas discharge and a low-speed above-the-water exhaust gas discharge of any known type.

The underwater exhaust gas discharge is shown primarily in FIG. 3 and includes a conduit 100 that depends through the lower unit 52 and which communicates through the hub underwater discharge formed in the propeller 54.

As has been previously noted, the trim and height of the propeller 54 can be adjusted and this adjustment will change the depth of submersion of the underwater discharge during engine running. In addition, various water conditions may also cause this height to vary during engine running. Thus, the back pressure on the exhaust system will be variable and this back pressure is particularly significant in effecting the rate of air flow in scavenging the combustion chambers 68 of the engine 44. Thus, a condition is present with marine applications that is not existent normally in automotive applications and which can seriously effect feedback control.

As the pistons 62 move downwardly in their cylinder bores 60 toward the bottom dead center position as shown in FIG. 4, the charge compressed in the crankcase chambers 72 will be compressed and eventually transfer to the respective engine combustion chamber, indicated generally by the reference numeral 68 through the scavenge passages 86 and scavenge ports 88 and 90 when they are opened by the movement of the piston 62. The flow of scavenging air is shown in FIGS. 4 and 5 by the arrows SA.

The engine 44 is provided with a direct cylinder fuel injection system. This fuel injection system is shown in part schematically in the upper portion of FIG. 2 and will now be described by particular reference to that figure. Before referring thereto, however, it should be noted that fuel injectors 102 are mounted in the cylinder head assembly 66 so as to spray fuel from this fuel supply system directly into the combustion chambers 68. The location and functioning of these fuel injectors 102 will be described after the system which supplies fuel to them has been described.

As is typical with outboard motor practice, the outboard motor 40 is supplied with fuel from a main fuel tank 104 that is normally mounted within the hull of the associated watercraft. Fuel is supplied from this tank 104 by a first low pressure pump 106 to a fuel filter 108 that is mounted within the protective cowling 48. The connection from the fuel tank 104 to the filter 108 includes a conduit 110 having a quick disconnect coupling of a known type.

A second, engine driven low pressure fuel pump 112 in the power head 42 collects the fuel from the fuel filter 108 and delivers it to a vapor separator, indicated generally by the reference numeral 114. The low pressure fuel pumps 112 may be of the type that are operated by crankcase pressure variations as is well known in this art.

The vapor separator 114 includes an outer housing 116 that is mounted at a suitable location within the protective cowling 48. A level of fuel, indicated at 118 is maintained in this housing 116 by a valve operated by a float 120.

Contained within the housing 116 is an electrically driven pressure pump 122 which develops a higher pressure than the pump 112 but a pressure that is not really high enough for effective high pressure direct cylinder injection.

This fuel is discharged from the vapor separator housing 116 through a supply conduit 124 to a high pressure, engine driven, positive displacement pump 126. The pump 126 may be of any known type and preferably has one or more plungers operated by cams for delivering extremely high pressures at a positive displacement. The pressure at which fuel is delivered to the high pressure pump 126 is regulated by a low pressure regulator 128 in a return line 130 that communicates the pressure line 124 back with the interior of the vapor separator body 114.

The high pressure pump 126 delivers fuel under pressure to a main fuel manifold 132 through a conduit in which a check valve 134 is positioned. A parallel conduit 136 extends around the high pressure pump 126 to the main fuel manifold. A check valve 138 is provided in this bypass line so that when the high pressure pump 126 is generating high pressure fluid, no flow will occur through the line 136.

A high pressure regulator 140 is provided in the main fuel manifold 132 and limits the maximum pressure of the fuel supply to the fuel injectors 102. This is done by dumping fuel back to the vapor separator assembly 114 through a return line 142. A fuel heat exchanger or cooler 144 may be provided in this return line 142 so as to ensure that the fuel is not at too high a temperature.

A pressure sensing device 146 is provided also in the main fuel manifold 132 for providing a fuel pressure signal to an ECU, indicated at 148 in FIG. 2 for controlling the engine systems, as will be described.

The main fuel manifold 132 supplies fuel to a pair of fuel rails 150 each of which is associated with a respective one of the cylinder banks. The fuel rails 150 each supply fuel in a known manner to the fuel injectors 102 of the respective cylinder banks.

As seen in FIGS. 4 and 5, the fuel injectors 102 are mounted in the cylinder head assemblies 66, in the illustrated embodiment, over the exhaust ports 92 on the exhaust side of the engine 44. These injectors 102 spray downwardly toward the heads of the pistons 62. The fuel injectors 102 are preferably of the solenoid operated type and have a solenoid valve which, when opened, controls the discharge of fuel into the combustion chambers 68 (as shown in broken lines in FIG. 4) so as to provide a fuel patch in the combustion chamber 68, the size of which depends upon the duration of fuel injection as will become apparent.

Spark plugs 152 are mounted in the cylinder head assemblies 66 and have their spark gaps disposed substantially on the axis of the cylinder bores 60. These spark plugs 152 are fired by an ignition circuit under the control of the ECU 148.

The ECU 148 controls the timing of firing of the spark plugs 152 and the beginning and duration of fuel injection by the injector 102. To this end, there is provided a number of sensors which sense either engine running conditions, ambient conditions or conditions of the outboard motor 40 that will effect engine performance. Certain of the sensors are shown schematically in FIG. 2 and will be described by reference to that figure. It should be readily apparent to those skilled in the art, however, that other types of sensing and control arrangements may be provided operating within the general parameters which will be set forth later having to do with the timing of initiation of fuel injection.

A crank angle sensor 154 is associated with the crankshaft 46. This sensor 154 provides not only a signal of crank angle but by comparing that signal with time an indication of crankshaft rotational speed.

There is also provided a crankcase pressure sensor 156 which senses the pressure in one or all of the crankcase chambers 72. By measuring crankcase pressure at a particular crank angle, engine air induction amount can be determined.

Engine or operator demand is determined by a throttle position sensor 158 that operates in conjunction with a throttle valve 78 so as to determine this function.

The ECU 148 operates on a feedback control condition and thus, an air fuel ratio sensor 160 is provided that communicates with the combustion chambers 68 or exhaust port 92 of at least one of the cylinder. Preferably, an oxygen sensor is utilized for this purpose, although other types of devices may be employed.

In order to provide a good indication of the fuel/air ratio, it is important that the oxygen sensor 160 is positioned so that it will sense the combustion products near the completion of combustion and before a fresh charge of air is delivered to the combustion chamber 68. Therefore, and as best shown in FIG. 4, the oxygen sensor 160 is provided so that its probe opens into the cylinder bore 60 at a point that is disposed slightly vertically above the upper edge of the exhaust port 92. In this way, the oxygen sensor 160 will be in a position to receive combustion products immediately before opening of the exhaust port 92 and most positively before the opening of the scavenge ports 88, 90 so that it will sense the combustion products at the time combustion has been substantially completed.

Engine temperature is sensed by an engine temperature sensor 162.

The temperature of the cooling water drawn from the body of water in which the watercraft or outboard motor 40 is operated is measured by a water temperature sensor 164. As has been noted, those sensors described may be just typical of any of the wide variety of sensors utilized for engine control.

In addition to controlling timing of firing of the spark plugs 152 and initiation and duration of fuel injection by the fuel injectors 102, the ECU 148 may also control a lubricating system. This is comprised of an oil supply system including a pump 166 that sprays oil into the intake passages 80 for engine lubrication. In addition, some forms of direct lubrication may be also employed for delivering lubricant directly to certain components of the engine.

It has already been noted that the adjustment of the angle of the propeller 54 will change the vertical position of its high-speed exhaust discharge and accordingly the back pressure. Thus, there are provided additional sensors which sense factors that will indicate this depth. These comprise an engine height sensor 168 that is mounted on the outboard motor 40 and which senses its height adjustment. Also, a trim angle sensor 170 is provided which senses the adjusted trim angle.

Other sensors may also be employed for control and some of these are associated with the engine 44 or the outboard motor 40 itself. These may include an engine vibration or knock sensor 172 and a neutral sensor 174. The neutral sensor 174 cooperates with the aforenoted forward, neutral, reverse transmission and will provide an indication of when the watercraft is operating in neutral.

Also shown schematically in FIG. 2 is a watercraft speed sensor 176 and a watercraft pitch sensor 178 that will sense the condition of the watercraft relative to the body of water and again indirectly the back pressure in the exhaust system. There is provided an atmospheric pressure sensor 180.

Because of the importance of the exhaust back pressure, as already noted, there is also provided an exhaust back pressure sensor 182 in one of the exhaust manifolds 94.

Of course, the sensors described are only typical of those types of sensors which may be employed. The components of the system as thus far described may be considered to be conventional and for that reason, where any component has not been illustrated or described in detail, reference may be had to conventional or known structures with which to practice the invention. The present invention deals primarily with a piston ring assembly. Accordingly, the following is a more detailed discussion of such a construction having features, aspects and advantages of the present invention.

With reference now to FIG. 6, a cut-away cross-section of a piston ring assembly arranged and configured in accordance with the present invention is illustrated therein. As discussed above, the piston 62 is received within the cylinder bore 60 for reciprocation. The piston 62 necessarily has a smaller overall outside diameter than the cylinder bore 60 in order to allow the reciprocation. Desirably, the piston operates within the oil bathed cylinder bore 60 of the internal combustion engine 44. The piston is desirable lubricated by oil L or another suitable lubricant as is known by those of skill in the art.

To seal the combustion chamber 68 from the balance of the cylinder and crankcase chamber 72, the piston 62 is provided with at least one piston ring. In the illustrated embodiment, the piston 62 ring assembly utilizes two piston rings, a top compression ring 200 and a lubricant control ring 202, to maintain the seal. The rings may be made of iron, steel or other suitable materials in any known manner.

The top compression ring 200 is retained in a top ring groove 204 in the piston 62. The top ring groove 204 circumscribes an uppermost portion of the piston 62 in a well-known manner. As is known, the ring groove 204 may comprise a top face 206 and a bottom face which are either substantially parallel to one another or, as illustrated, the faces 206, 208 may diverge from one another at they progress radially outward. Desirably, the faces may be spaced from one another at an inner surface 210.

The top compression ring 200 is sized for confinement within and around the radially outwardly opening annular top ring groove 204. The top ring groove 204 and the top compression ring 200 act, along with a head of the piston 62, as a first barrier for partially sealing off a lower end of the combustion chamber 68 from a lower portion of the cylinder below the top compression ring 200. Accordingly, the top compression ring 200 projects radially out of the groove 204 and has an outer surface 212 which is desirably parallel to the cylinder wall, which surface slidably bears against the same cylinder wall. The inner diameter of the compression ring 200 is desirably greater than the diameter of the inner surface of the ring groove 204 such that a gap is defined between the two members.

During compression and expansion strokes of the piston 62, the top compression ring 200 will act as an effective seal against a majority of the oil L deposited on the wall of the cylinder bore 60. As the gas pressure increases during the upward movement of the piston during the compression stroke, a corresponding pressure increase occurs on the top surface of the ring as well as against the radially inner surface of the ring forcing such ring with sufficient tension against the oil film of the bore wall. Good ring tension is facilitated by the ultra low friction of the rings against the groove walls.

The lubricant control ring 202 is received by a second piston ring groove 214 which is set apart from the first ring groove 204 by a land 215. The second piston ring groove has a top surface 216 and a bottom surface 218. An interior wall 220 separates the innermost portions of the top surface 216 from the bottom surface 218. As illustrated, the top surface 216 and the bottom surface 218 may be diverge from one another or, as discussed above, the two surfaces 216, 218 of the ring groove 214 may be substantially parallel to one another.

The control ring 202 is sized and configured to allow the lubricant control ring 202 to move somewhat within the second piston ring groove 214. The configuration of the control ring 202 will be described in an upstroke orientation. The control ring 202 has a top surface 222 that may slope gently upward in an outward direction. The control ring 202 also has a bottom surface 224 which is substantially parallel to the bottom surface 218 of the second ring groove 214. Desirably, the top surface 222 has a greater diameter than the bottom surface 224. A reverse-taper face 226 extends from the outermost periphery of the top surface 222 and the outermost periphery of the bottom surface 224. A wiping edge is an external edge 228 at the intersection of the top surface 222 and the reverse-taper face 226. While the illustrated embodiment has a linear edge in cross-section, it is anticipated that the edge may also be concavely or convexly curved.

The reverse-taper face 226 extends downward away from the top of the cylinder bore 60 at a substantially obtuse angle with the cylinder bore sidewall. The relatively obtuse angle allows the wiper edge to easily skim lubricant during the piston downstroke while also allowing the wiper edge to deliver lubricant upward toward the compression ring 204 during the piston upstroke. Accordingly, the control ring 202 may be designed to have contact force somewhat lower than that of the upper compression ring.

While the rings 200, 202 are relatively close fit within the grooves 204, 214, the rings fit the grooves so as to provide a slight gap between the top surfaces and the overlying surfaces of the grooves. The vertical width of the gap, as well as the angle of the gaps, is exaggerated in FIG. 6 for illustrative purposes. The gap is present between the top surfaces of the rings and the overlying surfaces for most of the piston stroke as the piston is in movement upwardly in the cylinder. Typically, lubricating oil L is splashed or otherwise deposited on and around the cylinder wall from the engine crankcase when the piston is at or near the upper end of its stroke (i.e., at approximately top-dead-center “TDC”).

Then, on the down stroke of the piston, the wiper edge of the ring tends to scrap a portion of the oil L deposited on the cylinder wall, while a portion of the oil L is left where originally deposited. Accordingly, as the piston completes the down stroke and reverses direction, oil L remaining on the wall above the wiper edge tends to accumulate between the wiper edge of the outer ring surface and the wall above the wiper edge. The oil L may then be forced upward to the top compression ring to lubricate the compression ring. Thus, the ring is better lubricated. The better lubricated ring wears more slowly and is less likely to score the cylinder bore.

With reference now to FIG. 7, a graphical presentation of top compression ring wear is illustrated. As illustrated, the prior embodiment, without the reverse-tapered edge forming an upward wiping edge, tended to wear more quickly. In the present embodiment, the top compression ring is better lubricated due to the upwardly forced oil L. Accordingly, the top compression ring wears substantially more slowly and is less likely to run dry and score the cylinder bore.

Although this invention has been described in terms of a certain embodiment, other embodiments apparent to those of ordinary skill in the art also are within the scope of this invention. Thus, various changes and modifications may be made without departing from the spirit and scope of the invention. Accordingly, the scope of the invention is intended to be defined only by the claims that follow.

What is claimed is:

1. A piston and piston ring assembly for a direct injection internal combustion engine, the piston comprising a head, at least two circumferential ring grooves positioned proximate the head, a compression ring positioned within the top ring groove and a second ring positioned within the second ring groove, the second ring having a top surface and a bottom surface wherein the top surface has a greater outside diameter than the bottom surface, a reverse-taper side surface extending between the outside edge of the top surface and the bottom surface, the upper end of the reverse-taper side surface forming a wiping edge of the second ring.

2. The piston and piston ring assembly of claim 1, wherein a tapered side face is substantially linear.

3. The piston and piston ring assembly of claim 1, wherein the top ring groove has an upper face, the upper face of the top ring groove and the top surface of the compression ring defining a gap such that the top ring can move up and down within the top ring groove.

4. The piston and piston ring assembly of claim 3, wherein the second ring groove has an upper face, the upper face of the second ring groove and the top surface of the second ring defining a gap such that the second ring can move up and down within the second ring groove.

5. The piston and piston ring assembly of claim 1, wherein the second ring groove also has an upper face, the upper face of the second ring groove and the top surface of the second ring defining a gap such that the second ring can move up and down within the second ring groove.

6. A piston and piston ring assembly for use within a cylinder of an internal combustion engine, the piston and piston ring assembly comprising a piston having a piston ring groove and a head, the piston ring groove having a width at its inner diameter, a piston ring positioned in the piston ring groove, the piston ring having a top surface generally facing toward the piston head and a thickness at its innermost edge, the top surface extending outward to a wiping edge, a face depending downward from the wiping edge and extending inward toward the piston, the piston ring thickness being less than the piston ring groove width and the wiping edge arranged to wipe a portion of a lubricant film from a cylinder wall.

7. The piston and piston ring assembly of claim 6 further comprising a second piston ring groove and a compression ring seated within the second piston ring groove, the second piston ring being interposed between the head of the piston and the first piston ring and a land being interposed between the second piston ring groove and the first piston ring groove, wherein the wiping edge of the first piston ring is arranged to wipe lubricant upward to the second piston ring during a piston ring upstroke.

8. The piston and piston ring assembly of claim 7, wherein the wiping edge of the first piston ring is arranged to wipe lubricant from a cylinder wall in a downward direction during a downstroke while leaving a thin film of lubricant in place on the cylinder wall.

9. The piston and piston ring assembly of claim 8, wherein the first piston ring is axially spaced from an inner wall of the piston ring groove.

10. The piston and piston ring assembly of claim 9, wherein the second piston ring is axially spaced from an inner wall of the piston ring groove.

11. The piston and piston ring assembly of claim 8, wherein the first piston ring is longitudinally spaced from a wall of the first piston ring groove.

12. The piston and piston ring assembly of claim 11, wherein the second piston ring is longitudinally spaced from a wall of the second piston ring groove.

13. The piston and piston ring assembly of claim 7, wherein the first piston ring is capable of translation within the first piston ring groove when the piston changes movement direction.

14. The piston and piston ring assembly of claim 7, wherein the second piston ring is capable of translation within the second piston ring groove when the piston changes movement direction 15. The piston and piston ring assembly of claim 6, wherein the top surface slopes upward toward its outside diameter.
